(19) United States
(12) Patent Application Publication
(10) Pub. No.: US 2026/0343555 A1
(43) Pub. Date: Oct. 29, 2026

(54) SCHEDULING OF MULTIPLE PHYSICAL CHANNELS WITH VARYING TRANSMISSION PARAMETER VALUES

(71) Applicant: Sony Group Corporation, Tokyo (JP)

(72) Inventors: Basuki PRIYANTO, Lund (SE); Shin Horng WONG, Basingstoke (GB)

(21) Appl. No.: 18/998,986

(22) PCT Filed: Aug. 4, 2023
(86) PCT No.: PCT/EP2023/071630

§ 371 Date: Jan. 27, 2025

(30) Foreign Application Priority Data
Aug. 5, 2022 (SE) 2250952-5

(51) Int. Cl. H04W 72/23; H04W 28/08; H04W 72/51

(52) U.S. Cl. CPC H04W 72/23; H04W 28/0925; H04W 72/51

(57) ABSTRACT

Multiple physical channels (611-614) are jointly scheduled using a scheduling message (699). Values of at least one transmission parameter associated with the multiple physical channels, e.g., modulation and coding scheme, frequency offset /719), timing offset, are varied across the jointly scheduled physical channels.

### TECHNICAL FIELD

Various examples of the disclosure generally relate to scheduling physical channels for communication of data. Various examples of the disclosure specifically relate to scheduling a plurality of physical channels using a single scheduling message.

### BACKGROUND

Various use cases of wireless communication require significant data rates to be supported by a wireless communication link. For instance, extended reality (XR) applications may require a continuous transmission with large packet size, e.g., for video streaming with high-resolution video frames to a wireless communication device (UE). An even larger packet size may be required in case there is a scene change in the video transmission. In such case, data compression techniques cannot reduce the amount of data significantly. Further, in such use cases, the receiving device shall continuously decode the received data packet. High latency due to the retransmission may affect user experience. Hence, high reliability and low latency are the key aspects in data transmission for XR applications.

### SUMMARY

There is a need for wireless communication links that support high data rates, e.g., for XR applications. There is a need for wireless communication links that support low latency communication.

This need is met by the features of the independent claims. The features of the dependent claims define embodiments.

Techniques are disclosed that facilitate communication, on a wireless communication link, of multiple different transport blocks (TBs). The different TBs include different higher-layer data packets. The TBs are mapped to a plurality of physical channels. The plurality of physical channels are scheduled using a single scheduling message. This pertains to joint scheduling of multiple physical channels. Specifically, physical shared channels can be jointly scheduled.

According to the various examples disclosed herein, such joint scheduling can be based on considerations regarding a reliability of the wireless communication link and/or a latency of the data packets mapped to the multiple TBs.

A method of operating a base station is disclosed. The method includes transmitting a scheduling message to a wireless communication device via a wireless communication link. The scheduling message schedules a plurality of physical channels to carry different transport blocks. Different physical channels are associated with different values of at least one transmission parameter. The method also includes communicating at least one of the plurality of physical channels between the base station and the wireless communication device. The at least one of the plurality of physical channels is communicated on the wireless communication link.

A base station is disclosed. The base station includes at least one processor and a memory. The at least one processor is configured to load program code from the memory and to execute the program code. The at least one processor, upon executing the program code, is configured to transmit a scheduling message to a wireless communication device via a wireless communication link. The scheduling message schedules a plurality of physical channels to carry different transport blocks. Different physical channels are associated with different values of at least one transmission parameter. The at least one processor, upon executing the program code, is further configured to communicate at least one of the plurality of physical channels between the base station and the wireless communication device. The at least one of the plurality of physical channels is communicated on the wireless communication link.

A computer program or a computer program product or a computer-readable storage medium includes program code. The program code can be loaded and executed by at least one processor. The at least one processor, upon executing the program code, transmits a scheduling message to a wireless communication device via a wireless communication link. The scheduling message schedules a plurality of physical channels to carry different transport blocks. Different physical channels are associated with different values of at least one transmission parameter. The at least one processor, upon executing the program code, further communicates at least one of the plurality of physical channels between the base station and the wireless communication device. The at least one of the plurality of physical channels is communicated on the wireless communication link.

A method of operating a wireless communication device is disclosed. The method includes receiving a scheduling message from a base station via a wireless communication link. The scheduling message schedules a plurality of physical channels to carry different transport blocks. Different physical channels are associated with different values of at least one transmission parameter. The method also includes communicating at least one of the plurality of physical channels between the base station and the wireless communication device. The at least one of the plurality of physical channels is communicated on the wireless communication link.

A wireless communication devices disclosed. The wireless communication device includes at least one processor and a memory. The at least one processor is configured to load program code from the memory and to execute the program code. The at least one processor, upon executing the program code, receives a scheduling message from a base station via a wireless communication link. The scheduling message schedules a plurality of physical channels to carry different transport block. Different physical channels are associated with different values of at least one transmission parameter. The at least one processor, upon executing the program code, further communicates at least one of the plurality of physical channels between the base station and the wireless communication device. The at least one of the plurality of physical channels is communicated on the wireless communication link.

A computer program or a computer program product or a computer-readable storage medium includes program code. The program code can be loaded and executed by at least one processor. The at least one processor, upon executing the program code, receives a scheduling message from a base station via a wireless communication link. The scheduling message schedules a plurality of physical channels to carry different transport block. Different physical channels are associated with different values of at least one transmission parameter. The at least one processor, upon executing the program code, further communicates at least one of the plurality of physical channels between the base station and the wireless communication device. The at least one of the plurality of physical channels is communicated on the wireless communication link.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a wireless communication system including a UE and a base station according to various examples.

FIG. 2 schematically illustrates a prior art implementation of scheduling messages and physical channels scheduled by the scheduling messages.

FIG. 3 schematically illustrates a prior art implementation of scheduling messages and physical channels scheduled by the scheduling messages.

FIG. 4 schematically illustrates a prior art implementation of scheduling messages and physical channels scheduled by the scheduling messages.

FIG. 5 schematically illustrates a prior art implementation of semi-persistent scheduling of physical channels.

FIG. 6 schematically illustrates scheduling multiple physical channels using a single scheduling message, the multiple physical channels carrying TBs having multiple values of a modulation and coding scheme according to various examples.

FIG. 7 schematically illustrates scheduling multiple physical channels using a single scheduling message, the multiple physical channels having multiple values of a frequency offset according to various examples.

FIG. 8 and FIG. 9 schematically illustrates scheduling multiple physical channels using a single scheduling message, the multiple physical channels having multiple values of a timing offset according to various examples.

FIG. 10 is a signaling diagram of communication between a base station and a UE according to various examples.

FIG. 11 is a flowchart of a method according to various examples.

FIG. 12 is a flowchart of a method according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof. Various examples of the disclosure pertain to communication of data packets on a wireless communication link between a base station (BS) of a cellular network (NW) and the UE. According to various examples, it is possible that the wireless communication link, the BS and the UE operate according to the Third Generation Partnership Project (3GPP) specification. Specifically, it would be possible that operation according to the 3GPP New Radio (NR) release-18 specification, or higher, is used. Hereinafter, techniques will be disclosed in connection with the 3GPP NR specification, but other specifications and protocol may also benefit from the techniques disclosed herein.

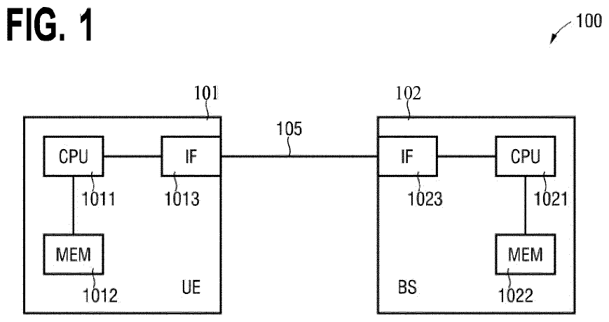

According to the techniques disclosed herein, the data packets of an application—e.g.,—including video frames—can be mapped to TBs. These TBs can be communicated between the BS and the UE in uplink (UL) direction or downlink (DL) direction in multiple physical channels (specifically physical shared channels) on the wireless communication link. Details are illustrated in FIG. 1.

FIG. 1 schematically illustrates a wireless communication system 100 according to various examples. A UE 101 and a BS 102 communicate via a wireless communication link 105, using respective communication interfaces 1013, 1023.

The UE 101, the BS 102 can operate according to the 3GPP NR specification. The wireless communication link 105 can define time slots that include respective resources that can be allocated to channels. Specifically, data packets can be mapped to TBs and the TBs can be accommodated in (i.e., carried by) physical channels, specifically, the Physical Downlink Shared Channel (PDSCH) in the DL and the Physical Uplink Shared Channel (PUSCH) in the uplink.

PDSCH is a downlink physical channel used to carry application data. A TB can be carried by a PDSCH and the PDSCH can be scheduled using a DL Dynamic Grant (DG) or via Semi-Persistent Scheduling (SPS). In a Dynamic Grant PDSCH (DG-PDSCH), the PDSCH resource is dynamically indicated by the BS using a DL Grant carried by a Downlink Control Information (DCI) in the Physical Downlink Control Channel (PDCCH). The DCI is transmitted in a defined resource on the Physical Downlink Control Channel (PDCCH). The DCI can also be used to implement the SPS. The DCI, accordingly, can implement a scheduling message. PUSCH is an uplink physical channel. Each PUSCH can carry a TB and the PUSCH can be scheduled using an UL Dynamic Grant provided by a DCI, thereby implementing a scheduling message.

The UE 101 includes a processor 1011 and a memory 1012. The processor 1011 can load program code from the memory 1012 and execute the program code. Upon executing the program code, the UE can perform techniques as disclosed herein, e.g., receiving a scheduling message and transmitting and/or receiving (communicating), on the wireless communication link 105, TBs in accordance with the scheduling message, implementing a communication protocol stack—e.g., according to the Open Systems Interface model-including multiple layers to communicate with the BS 102, etc.

The BS 102 includes a processor 1021 and a memory 1022. The processor 1021 can load program code from the memory 1022 and execute the program code. Upon executing the program code, the BS 102 can perform techniques as disclosed herein, e.g., transmitting a scheduling message, communicating multiple PDSCHs and/or PUSCHs in accordance with the scheduling message on the wireless communication link 105, implementing a communication protocol stack—e.g., according to the Open Systems Interface model—including multiple layers to communicate with the UE 101, scheduling physical channels on the wireless communication link 105, etc.

Scheduling of a physical channel pertains to the process of distributing resources (e.g., time-frequency resources, and optionally code and/or spatial resources) on the wireless communication link between different UEs so that collisions are avoided. When scheduling, the BS 102 can take into account a reliability of communication on the wireless communication link 105 and/or a latency of data packets mapped to the TBs. Latency requirements may be imposed by a higher-layer application, e.g., an XR application.

The data packets mapped to the TBs can include payload data of an application. Different TBs (mapped to different PDSCHs or PUSCHs) carry different data packets.

For example, the data packets can carry payload data of an XR application. XR and Cloud Gaming refer to various types of augmented, virtual, and mixed environments, where human-to-machine and human-to-human communications are performed with the assistance of handheld and wearable end user devices (UEs). XR and Cloud Gaming are two applications that are considered important for 3GPP NR Rel-18 and beyond (also known as 5G Advanced). Hence, a Rel-18 Study Item on XR has been approved in 3GPP to study potential enhancements to the legacy 5G system for support of XR traffic. See RP-220285, “Revised SID: Study on XR Enhancements for NR,” Nokia (Rapporteur), RAN #95e, 2022-03.

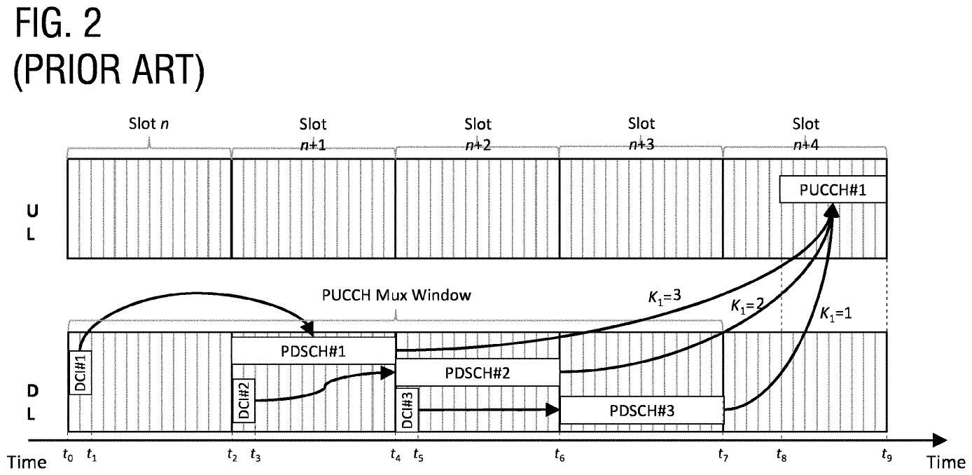

In the case of DL communication, the TBs according to 3GPP NR specification are carried in the PDSCHs. The legacy operation of PDSCHs, including dynamic grant (DG) PDSCH and SPS are described next in connection with FIG. 2 to FIG. 5. PDSCH is an implementation of a physical channel

FIG. 2 schematically illustrates a DG scheduling of PDSCH. PDSCH is transmitted using Hybrid Automatic Repeat Request (HARQ) transmission, where for a PDSCH ending in slot n, the corresponding PUCCH carrying the HARQ-ACK (HARQ acknowledgement) is transmitted in slot n+K₁, where, in DG PDSCH, the value of K₁ is indicated in the field “PDSCH-to-HARQ_feedback timing indicator” of the DL Grant (carried by DCI Format 1_0, DCI Format 1_1 or DCI Format 1_2) (In FIG. 2 and the remaining FIGs., each PDSCH or PUSCH carries a respective TB). Multiple (different) PDSCHs can point to the same slot for transmission of their respective HARQ-ACKs and these HARQ-ACKs (in the same slot) are multiplexed into a single PUCCH. Hence a PUCCH can contain multiple HARQ-ACKs for multiple PDSCHs. In the example of FIG. 2, three DL Grants are transmitted to the UE via DCI #1, DCI #2 and DCI #3 in slot n, n+1 and n+2 respectively. DCI #1, DCI #2 and DCI #3 schedule PDSCH #1, PDSCH #2 and PDSCH #3 respectively. DCI #1, DCI #2 and DCI #3 further indicate K₁=3, K₁=2 and K₁=1 respectively. Since the K₁ values indicate that the HARQ-ACK feedbacks for PDSCH #1, PDSCH #2 and PDSCH #3 are transmitted in slot n+4, the UE multiplexes all of these HARQ-ACKs into a single PUCCH, i.e. PUCCH #1. The PUCCH Multiplexing Window is a time window where PDSCHs can be multiplexed into that PUCCH and the size of the PUCCH multiplexing window depends on the range of K₁ values. In the example in Fehler! Verweisquelle konnte nicht gefunden werden., the PUCCH Multiplexing Window is from Slot n to Slot n+3, which means the max K₁ value is 4 slots.

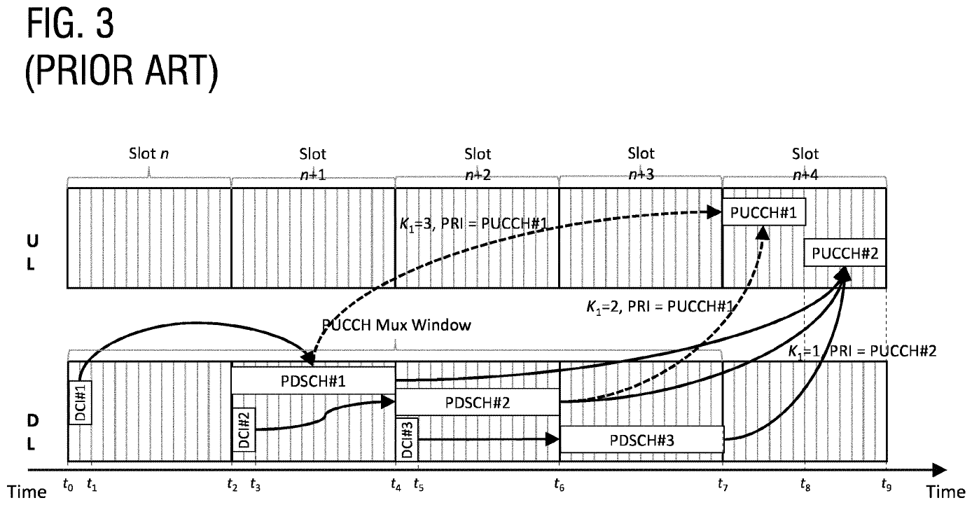

In 3GPP Rel-15, only one PUCCH per slot is allowed to carry HARQ-ACKs for the same UE even if the different PUCCHs do not overlap in time. The PUCCH resource is indicated in the “PUCCH Resource Indicator” (PRI) field in the DL Grant. Each DL Grant may indicate a different PUCCH resource, but the UE will follow the PRI indicated in the last PDSCH in the PUCCH Multiplexing Window since the UE only knows the total number of HARQ-ACK bits after the last PDSCH is received. An example is shown in FIG. 3, where DCI #1 and DCI #2 indicate PUCCH #1 for the HARQ-ACKs corresponding to PDSCH #1 and PDSCH #2, but DCI #3 indicates PUCCH #2 for the HARQ-ACK corresponding to PDSCH #3. Here, PUCCH #1 and PUCCH #2 do not overlap in time. Since DCI #3 schedules the last PDSCH, i.e., PDSCH #3, in the Multiplexing Window, the UE will use PUCCH #2 to carry the HARQ-ACK for PDSCH #1, PDSCH #2 and PDSCH #3. Further, PUCCH carrying other UCI such as SR (Scheduling Request) can be transmitted separately to a PUCCH carrying HARQ-ACK within the same slot if they do not overlap in time.

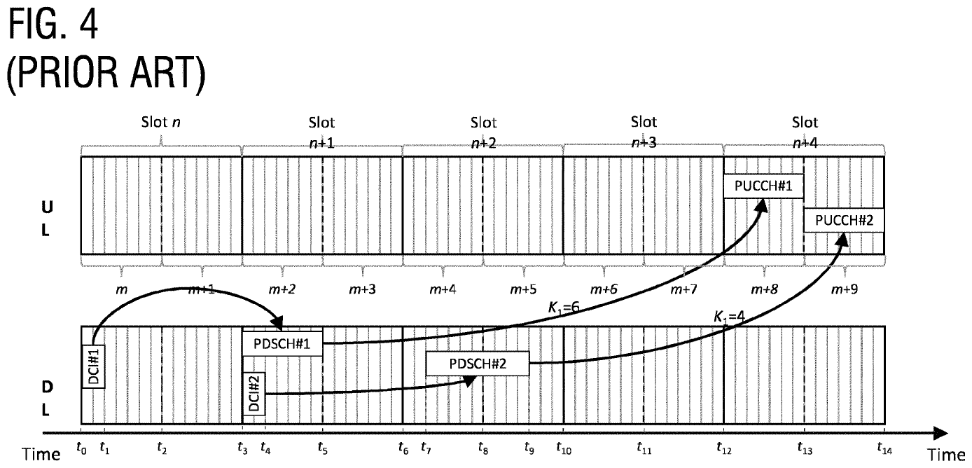

In 3GPP Rel-16 eURLLC, sub-slot PUCCH was introduced for carrying HARQ-ACK for URLLC PDSCH. Sub-slot based PUCCH allows more than one PUCCH carrying HARQ-ACKs to be transmitted within a slot. This gives more opportunity for PUCCH carrying HARQ-ACK for PDSCH to be transmitted within a slot, thereby reducing latency for HARQ-ACK feedbacks. In a sub-slot based PUCCH, the granularity of the K₁ parameter (i.e., the time difference between the end of PDSCH and the start of its corresponding PUCCH) is in units of sub-slot instead of slot, where the sub-slot size can be 2 symbols or 7 symbols. An example is shown in FIG. 4, where the sub-slot size=7 symbols (i.e. half a slot) and the sub-slots are labelled as m, m+1, m+2, etc. PDSCH #1 is transmitted in slot n+1 but for sub-slot based HARQ-ACK PUCCH, it is considered to be transmitted in sub-slot m+2 and here K₁=6 which means that the corresponding HARQ-ACK is in sub-slot m+2+K₁=m+8. PDSCH #2 is transmitted in slot n+2 but occupies sub-slots m+4 and m+5. The reference for K₁ is relative to the sub-slot where the PDSCH ends and in this case PDSCH #2 ends in sub-slot m+5. The DL Grant in DCI #2 that schedules PDSCH #2 indicates K₁=4 which schedules a PUCCH for its HARQ-ACK at sub-slot m+5+K₁=sub-slot m+9. In SPS PDSCH, the PDSCH resources are RRC configured and occur periodically where each SPS PDSCH occasion has a pre-configured and fixed duration. This allows the BS to schedule traffic that has a known periodicity and packet size. The BS may or may not transmit any PDSCH in the SPS PDSCH occasion but the UE needs to monitor each SPS PDSCH occasion for potential PDSCH transmission. The number of scheduled SPS PDSCHs is not predetermined, because the SPS PDSCHs are scheduled until further notice.

In 3GPP Rel-15 the UE can only be configured with one SPS PDSCH and this SPS PDSCH is activated using an activation DCI (Format 1_0 or 1_1) with the CRC scrambled with CS-RNTI. Once an SPS PDSCH is activated, the UE will monitor for potential PDSCH in each SPS PDSCH occasion of the SPS PDSCH configuration without the need for any DL Grant until the SPS PDSCH is deactivated. Deactivation of the SPS PDSCH is indicated via a deactivation DCI scrambled with CS-RNTI. The UE provides a HARQ-ACK feedback for the deactivation DCI but no HARQ-ACK feedback is provided for an activation DCI.

Similar to DG-PDSCH, the slot containing the PUCCH resource for HARQ-ACK corresponding to SPS PDSCH is indicated using the K1 value in the field “PDSCH-to-HARQ_feedback timing indicator” of the activation DCI. Since DL Grant is not used for SPS PDSCH, this K1 value is applied for every SPS PDSCH occasion and can only be updated after it has been deactivated and re-activated using another activation DCI with a different K1 value. The activation DCI also schedules the MCS, time (TDRA) and frequency (FDRA) resources within the periodic subframe of the PDSCH.

Since there is only one SPS PDSCH, PUCCH Format 0 or 1 is used to carry the HARQ-ACK feedback. If the PUCCH collides with a PUCCH carrying HARQ-ACK feedbacks for DG-PDSCH, the HARQ-ACK for SPS PDSCH is multiplexed into the PUCCH corresponding to DG-PDSCH.

In 3GPP Rel-16 the UE can independently be configured with up to eight SPS PDSCHs, where each SPS PDSCH has an SPS Configuration Index that is RRC configured. Each SPS PDSCH is individually activated using a DCI (Format 1_0, 1_1 & 1_2) with the CRC scrambled with CS-RNTI, where it indicates the SPS Configuration Index of the SPS PDSCH to be activated. However, multiple SPS PDSCHs can be deactivated using a single deactivation DCI. Similar to Rel-15, the UE provides a HARQ-ACK feedback for the deactivation DCI but does not provide one for the activation DCI.

The slot or sub-slot containing the PUCCH resource for HARQ-ACK feedback corresponding to a SPS PDSCH occasion is determined using the K1 value indicated in the activation DCI. Since each SPS PDSCH configuration is individually activated, different SPS PDSCH can be indicated with different K1 values.

Since different K1 values can be used for different SPS PDSCH configurations, it is possible that the HARQ-ACK for multiple SPS PDSCHs point to the same slot or sub-slot and in such a scenario, these HARQ-ACKs are multiplexed into a single PUCCH. For multiple SPS PDSCH configurations, PUCCH Format 2, 3 & 4 (in addition to PUCCH Format 0 & 1) can be used to carry multiple HARQ-ACKs for SPS PDSCH. Here the HARQ-ACKs in the PUCCH are sorted in ascending order according to the DL slot for each of the SPS PDSCH Configuration Indices and then sorted in ascending order of the SPS PDSCH Configuration Index.

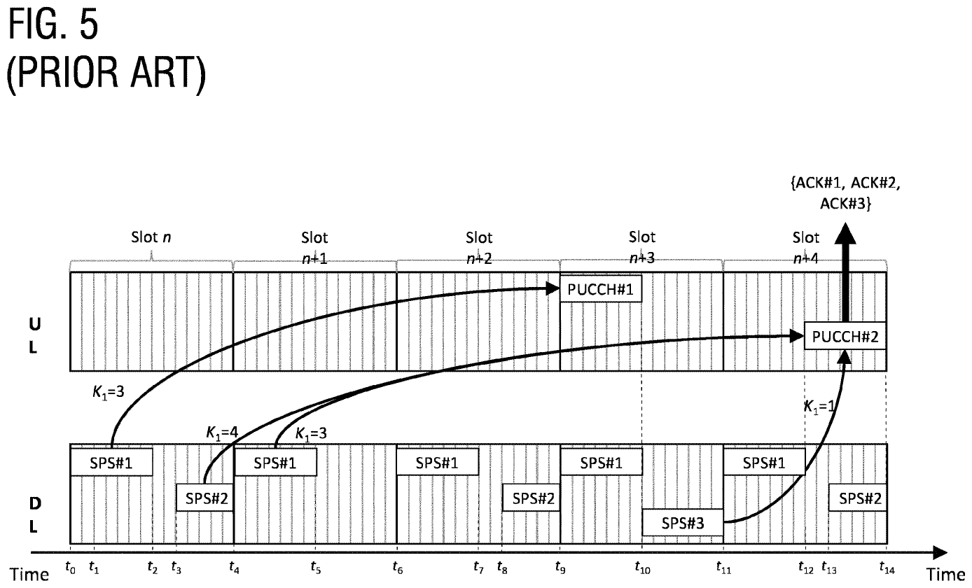

Since typically the K₁ value is fixed per SPS PDSCH then it is unlikely to have two or more SPS PDSCHs with the same index multiplexed into a PUCCH. An example is shown in FIG. 5, where a UE is configured with 3 SPS PDSCHs labelled as SPS #1, SPS #2 and SPS #3 with different periodicities that are RRC configured with SPS Configuration Index 1, 2 and 3 respectively. SPS #1, SPS #2 and SPS #3 are activated with K₁=3, K₁=4 and K₁=1 respectively. These K₁ values result in the PUCCH for HARQ-ACK feedbacks corresponding to SPS #2 in Slot n, SPS #1 in Slot n+1 and SPS #3 in Slot n+3 being in the same slot, i.e. carried by PUCCH #2 in Slot n+4. PUCCH #2 therefore provides 3 HARQ-ACKs labelled as {ACK #1, ACK #2, ACK #3} for SPS #1, SPS #2 and SPS #3 respectively according to their SPS PDSCH Configuration Indices (note that in this example, there is only one unique SPS PDSCH per DL slot that have HARQ-ACK multiplexed into PUCCH #2). When the PUCCH for SPS PDSCHs collides with PUCCH for DG-PDSCH, their HARQ-ACKs are multiplexed where the SPS PDSCH HARQ-ACKs are appended after those for DG-PDSCH.

Various techniques are based on the finding that such existing techniques of scheduling PDSCHs or PUSCHs, e.g., as illustrated above in connection with FIG. 2 to FIG. 5, have certain deficiencies and drawbacks in connection with accommodating data packets of certain applications requiring large data rates and low latencies, e.g., XR applications. This is explained in the following.

A unit of a video transmission (e.g., a video frame) is ideally transmitted in a large packet size (e.g., PDSCH with a large TB size, TBS). However, the transmission using radio-interface may have limited radio resources (e.g., bandwidth), there may be multiple transmissions to multiple UEs making the allocation of a single large TBS difficult, and the radio resource allocation may also be affected by the channel conditions. Hence, the transmission of a video frame in a single TB may not always be possible.

A video transmission in XR must be processed sequentially, e.g., per-frame based. After a successful decoding of a video frame, the receiving device will continue in decoding the next video frame. In case of a failure in decoding a video frame, the receiving device either drops that video frame and continues to the next one or receives a retransmission of the failed video frame and attempts to decode it prior to processing the next one. Dropping the video frame will reduce the user experience. The retransmission can only be supported as long as it is still within the packet delay budget (PDB). Otherwise, it will increase the latency and result in reducing the user experience.

To mitigate these issues, hereinafter, techniques are disclosed according to which a single scheduling message—e.g., a Layer 1 message such as a DCI on the PDCCH—can be used to schedule a plurality of physical channels, e.g., a plurality of PDSCHs or a plurality of PUSCHs. Different physical channels can then carry different TBs. There can be a one-to-one mapping between PDSCHs or PUSCHs and TBs. Different physical channels that are jointly scheduled by the single scheduling message can be associated with different values of at least one transmission parameter. In other words, subsequent PDSCHs or PUSCHs can have different transmission properties than the first transmission. Such transmission properties may be defined on Layer 1, i.e., the physical layer.

The single scheduling message, such as DCI on a PDCCH, schedules multiple physical channels such as PDSCH or PUSCH, where each physical channel carries a different TB. In addition to each TB carrying different user data, they may also have different sizes or use different encoding parameters (coding rate and modulation) resulting in the corresponding physical channel having different MCS, frequency & time resources. The term multi-TB may be used to describe the scheme of using a single scheduling message to schedule multiple physical channels where each physical channel can carry a different TB. The term TB and physical channel may be used interchangeably to describe this scheme.

For example, a predetermined number of physical channels may be scheduled by the scheduling message. This means that—in contrast to SPS—a certain fixed number is scheduled.

The value of various transmission parameters can be varied across the plurality of physical channels. Some examples of relevant transmission parameters are summarized in TAB. 1 below.

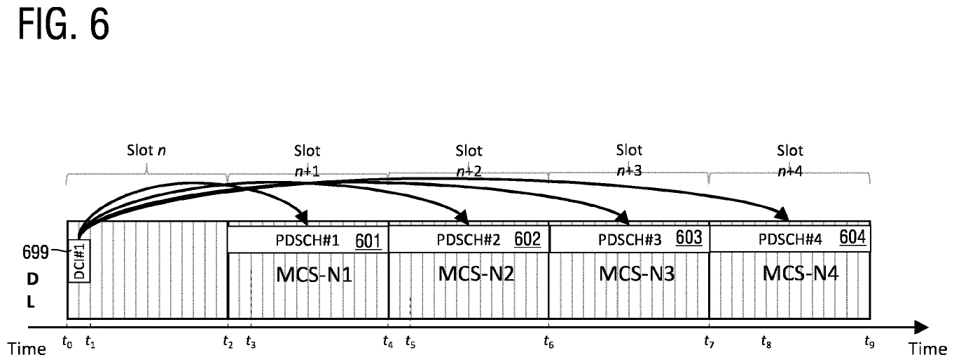

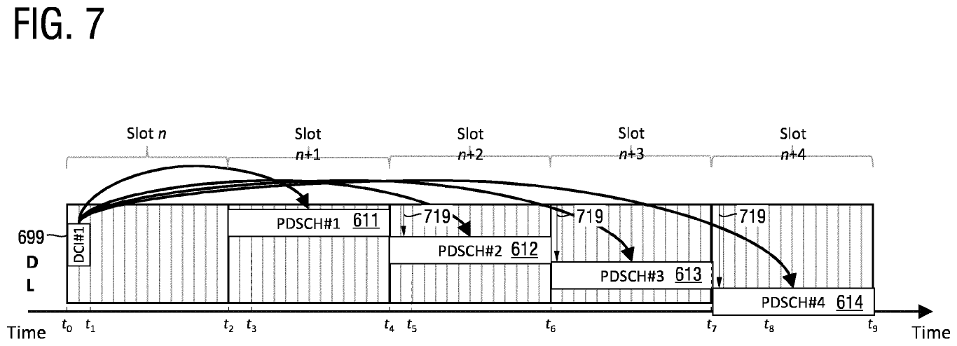

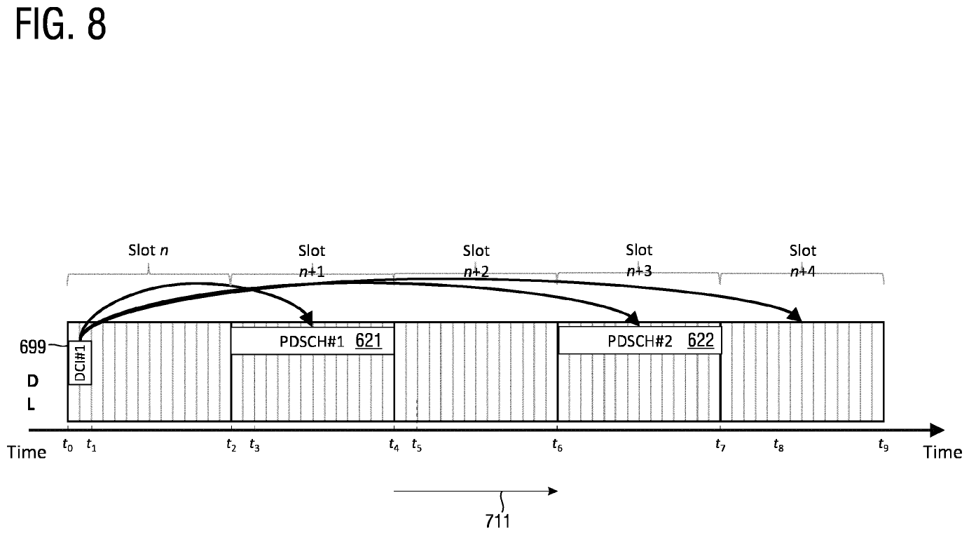

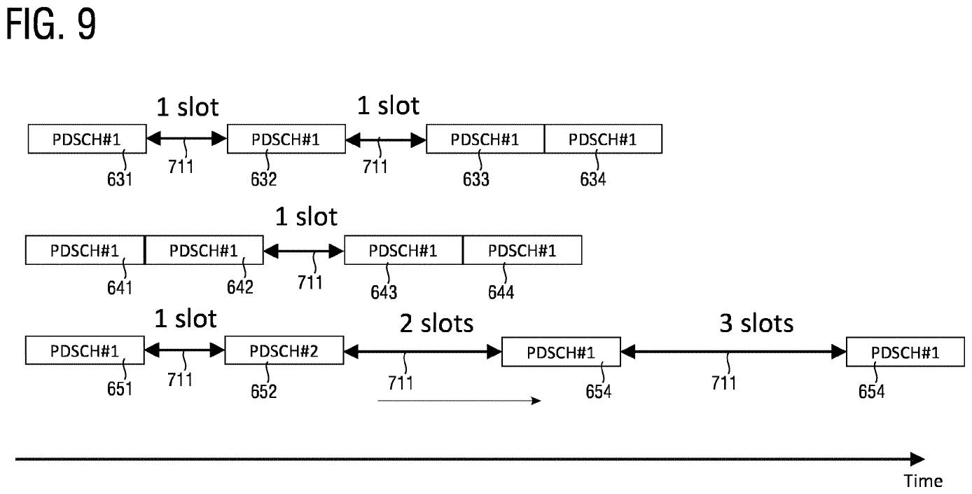

TABLE 1
Various examples of transmission parameters that can have two or more
values across multiple physical channels that are jointly scheduled
by a single scheduling message according to various examples. It
is possible to combine these examples to form further examples.

| | TRANSMISSION | |
|---|---|---|
| | PARAMETER | EXAMPLE DETAILS |
| I | Modulation and | The value of the modulation and coding scheme |
| | Coding Scheme | (MCS) can be varied from one physical channel |
| | (MCS) | to another physical channel. An example is |
| | | illustrated in FIG. 6. |
| II | Frequency | The frequency offset can be varied from one |
| | allocation | physical channel to another physical channel. An |
| | | example is illustrated in FIG. 7. |
| III | Time-Gap | A timing offset can be varied from one physical |
| | | channel to another physical channel, wherein an |
| | | example is illustrated in FIG. 8 and FIG. 9. |
| IV | Resource size | The resource size of time-frequency resources |
| | | allocated on the wireless communication link to |
| | | each physical channel can be varied from one |
| | | physical channel to another physical channel. |

As a general rule, to define the concrete values of the at least one transmission parameter across the physical channels, different techniques can be employed. For instance, the varying values of the at least one transmission parameter can be fixedly configured, e.g., according to the 3GPP specification. It would also be possible that the varying values are pre-configured using a higher-layer control message, e.g., a Layer 3 control message such as a Radio Resource Control (RRC) control message.

In some examples, it would also be possible that the scheduling message includes an indicator that determines, fully or partly, the different values of the at least one transmission parameter. This means that the scheduling message can be used to instruct the UE how to vary the values of at least one transmission parameter—cf. TAB. 1—from a physical channel carrying a TB to another physical channel carrying a different TB; sometimes, in combination with further pre-configured or fixed information. Such techniques have the advantage that the BS can react to instantaneous channel conditions of the wireless communication link. The BS can monitor the channel conditions and then schedule the physical channel and determine the values of the at least one transmission parameter appropriately, depending on the instantaneous channel condition. The scheduling message can then be used to convey this information on the values to-be-used to the UE. For instance, if a temporary drop in the reliability of communicating on the wireless communication channel is observed—e.g., due to a signal fade—then the current reliability of communicating on the wireless communication channel is low; accordingly, it would be possible to select a more robust modulation and coding scheme—cf. TAB. 1: example I—for the initial physical channel carrying a TB if compared to later occurring physical channels carrying other TBs (for which it can be expected that the temporary signal fade is over). This means that the level of the modulation and coding scheme may be increased across the jointly scheduled physical channels in case a temporary drop of the channel condition is expected to be brief and affects only the initial few physical channels whilst subsequent physical channels are likely to be outside of this temporary drop in channel condition and therefore can benefit from a higher MCS (i.e., less robust modulation/coding, but higher throughput). On the other hand, if such a temporary drop of the channel condition of the wireless link is not observed, the modulation and coding scheme level may be decreased across the jointly scheduled physical channels. This is because the uncertainty in the prediction of the channel condition tends to increase when the prediction is extended into the future. Such strategies are only examples. The BS scheduler can use other scheduling algorithms to decide whether the channel condition is expected to be better or worse after the transmission of the initial few physical channels and this invention provides the scheduler the mechanism to increase or decrease the MCS for the transmissions of the multiple physical channels to benefit from the changes in channel conditions. Such qualitative variation of the value of the MCS is only one example and other qualitative dependencies of the value of the MCS and/or other transmission parameters are conceivable.

The MCS level is typically defined by an MCS table. Different MCS table entries have different indices, the MCS level. Typically, lower MCS levels have more robust modulation, e.g., Binary Phase Shift Keying or Quadrature Phase Shift Keying, while higher MCS levels have less robust modulation which offers higher throughputs, e.g., Quadrature Amplitude Modulation, e.g., from 16-QAM to 256-QAM. The modulation order can increase with increasing MCS level. Similar consideration can also apply to the coding scheme, e.g., the length of the forward error checksum, etc.

There are different options available for providing the scheduling message such that includes an indicator that determines at least partly the different values of the at least one transmission parameter.

In one option, the scheduling message may explicitly encode the values to be used across the physical channels (carrying different TB). For instance, the MCS values are defined by the 3GPP specification by a MCS lookup table and the particular entry in the MCS lookup table may be encoded in the scheduling message, e.g., “20”-16″-“2”, to give one example. For each value, a respective multi-bit indicator. A bitmap can be provided, each bitmap entry corresponding to a respective value.

The values to be used may also be indicated less explicitly. For instance, it would be possible that the scheduling message includes an indicator indicative of an offset between different values of the at least one transmission parameter. In other words, it would be possible that the initial value of the first physical channel carrying a first TB of the multiple physical channels is indicated (e.g., as a reference value); as well as the incremental offset towards the second physical channel of the multiple physical channels, from the second to the third physical channel, and so forth. Typically, the size of the incremental offset can be significantly smaller than the size of the value itself; so that fewer bits may be required to signal the offset than signaling the value itself. It would also be possible that the offset between adjacent physical channels is fixed across the jointly scheduled physical channels. For instance, if the initial value is “2” and the fixed offset is “2”, then values would be “2”-“4”-“6” and so forth. In such a scenario, only a single incremental offset value is be signaled. In some scenarios, multiple candidate offsets may be pre-defined and the scheduling message may select the offset from the candidate offsets.

In a further scenario, a selection of the different values of the at least one transmission parameter is achieved by the indicator. The selection can be from multiple candidate values (or, specifically, multiple sets of candidate values, each set including the a respective number of values for the multiple physical channels) that are predetermined at, both, the BS and the UE. This means that various options for sets of values of the at least one transmission parameter to be used across the multiple physical channels can be available and a selection from amongst this multitude of sets is then achieved by the scheduling message. The scheduling message can include a respective pointer. A look-up table with the multiple choices can be pre-defined. This has the advantage that the size of the scheduling message can be reduced, because a comparatively small indicator can be used to make such selection. The values themselves need not to be communicated as part of the scheduling message. Such a reduced size of the scheduling message is, in particular, helpful where a scheduling message is used that is native to a lower layer of the communication protocol stack, e.g., a DCI that is native to Layer 1, i.e., the physical layer. There are different options available for implementing such a selection of the different values of the at least one transmission parameter from candidate values. For instance, the indicator included in the scheduling message can be explicitly indicative of the selection. For instance, in case there are four different choices, a 2-bit indicator may be used in the scheduling message that explicitly indicates which choice of values to-be-used to select. Also, the selection can be implicit, e.g., taking into account a predetermined rule.

More generally, it would also be possible that the determining of the different values of the at least one transmission parameters in accordance with a predetermined rule that is defined at, both, the BS and the UE. Such techniques correspond to partly defining on the multiple values to be varied across the multiple physical channels in the scheduling message. The UE can then interpret the scheduling message using some prior knowledge, i.e., the predetermined rule, to thereby derive the concrete values. This helps to further reduce the size of the scheduling message. The predetermined rule can translate the indicator into a concrete selection of values to-be-used for the transmission parameter across the multiple physical channels. The predetermined rule may specify a UE-specific parameter. For instance, depending on a UE identity, different values may be selected. The predetermined rule may specify one or more constraints, e.g., upper or lower bounds for the values of the at least one transmission parameter. Then, the sequence of values can be constrained by such bounds. In a further scenario, the predetermined rule can be implemented as a lookup table and an entry of the lookup table can be specified by the scheduling message. The predetermined rule can also take more complex forms, e.g., include calculations. The predetermined rule may or may not take into account one or more UE-centric decision criteria, i.e., may be parametrized based on one or more parameters that can be observed by the UE without receiving respective information from the BS as part of the scheduling message. For example, the predetermined rule may translate the indicator included in the scheduling message based on a currently used bandwidth part or carrier frequency into the concrete values to be used for the at least one transmission parameter across the multiple physical channels. The predetermined rule may be fixedly configured at the UE and the BS. It would also be possible that the predetermined rule is preconfigured using a higher-layer control message. It would be possible that a configuration message that is indicative of the predetermined rule is communicated between the UE and the BS. For instance, an RRC control message can be used, i.e., the configuration message that is indicative of the predetermined rule can be native to layer 3 of the communication protocol stack.

As will be appreciated from the above, various concepts are available for specifying the values of the at least one transmission parameter. Next, some concrete examples will be provided, for the different examples of transmission parameters that are summarized in TAB. 1.

First, in connection with a variation of the value of the MCS, some examples are provided below. This corresponds to example 1 of TAB. 1. Here, different physical channels are configured to use different MCS.

Each physical channel may have different MCS or a subset of physical channels (e.g., at least two PDSCHs or PUSCHs) may have different MCS.

The UE may be semi-statically configured with a set of values of the MCS. The set can be in the form of an offset to the value of the MCS indicated in the DL/UL grant. For example, the set can be configured as {+1, +2, −3} by a scheduling message scheduling four physical channels.

Referring to FIG. 6, the MCS field in DCI #1—implementing the scheduling message 699—indicates a value of the MCS=5 for the physical channel 601 then the following values of the MCS are derived for the subsequent physical channels: physical channel 602 has the value of the MCS as indicated in the DCI incremented by 1, i.e., 5+1=6. Physical channel 603: MCS value given by 5+2=7; physical channel 604: MCS value given by 5−3=2. As will be appreciated, the scheduling message 699—here implemented by the DCI—is indicative of a reference value of the modulation and coding scheme and then the different values of the modulation and coding scheme are determined for the different physical channels 601-604 based on the reference value. The reference value is the MCS value indicated by the scheduling message 699 and used for the first physical channel 601. The values of the MCS for the subsequent physical channels 602-604 are obtained by adding the respective offset value.

In a further scenario, the UE is configured with multiple sets of offset values for the MCS, i.e., 2 or more sets. The scheduling message then can include a pointer to a specific set. This scenario corresponds to a selection from multiple candidate values, as explained above. For example, the UE is configured with two sets of values of the MCS: Δ-MCS1={+1, +2, +3}; and Δ-MCS2={0, −2, −3}. The BS can then indicate in the DL/UL Grant, e.g. using 1 bit whether the UE should use Δ-MCS1 or Δ-MCS2. For example, if the BS is optimistic of the radio condition, it may apply Δ-MCS1 where the MCS increases for each subsequent PDSCH/PUSCH and if the BS is pessimistic of the radio condition, it may apply Δ-MCS2, where the MCS decreases for each subsequent PDSCH/PUSCH.

In a further scenario, the scheduling message is indicative of an incremental increase or decrease in the level of the modulation and coding scheme from physical channel to physical channel. In other words, it is possible that the UE is given an MCS step size where the UE applies this step size for each subsequent physical channel. This corresponds to providing an offset value, as explained above. It is thus possible that the scheduling message includes an indicator indicative of at least one MCS offset, thereby incrementally defining the different values of the MCS. For example, the MCS Step Size=+2, and the indicated MCS in the DL Grant=3, and the number of physical channel to be transmitted is 6, then the MCS value for first PDSCH=3, second PDSCH=5, third PDSCH=7, fourth PDSCH=9, fifth PDSCH=11 and sixth PDSCH=13. The MCS step size/offset value can be indicated in the DL/UL Grant, i.e., in the scheduling message, or can be semi-statically configured. In a sub-scenario for semi-statically configured MCS step sizes, the UE is configured with multiple candidate MCS step sizes and the BS indicates one of these MCS step sizes dynamically in the scheduling message. For example, the UE is configured with three candidate MCS step sizes, e.g. Step1=0, Step2=+1, Step3=−1. The BS indicates in the scheduling using 2 bits which MCS step size to use. Step1 is used if the BS wants to maintain the MCS in all the scheduled PDSCHs or PUSCHs, Step2 is used if the BS is optimistic of the radio condition and Step3 is used if the BS is pessimistic of the radio condition.

In such scenarios, it is possible that the values of the MCS are selected in accordance with at least one of a predetermined upper bound or a predetermined lower bound. If a physical channel has a determined value of the MCS that is greater than a predefined maximum value of the MCS, then that physical channel will use the maximum value, i.e., the upper bound. The upper bound can be configurable, e.g., using an RRC control message providing the configuration, or it can be the highest MCS value defined in the 3GPP specification, e.g., MCS=32. On the other hand, if a physical channel has a value of the MCS that is smaller than a predefined minimum value of the MCS, then this physical channel can use the minimum value, i.e., the lower bound. Again, the lower bound can be configurable, e.g., using an RRC control message providing the configuration, or it can be the lowest MCS value defined in the 3GPP specification, e.g., MCS=0.

Above, example 1 of TAB. 1 has been discussed, i.e., variation of the value of the MCS across the physical channels of the multiple scheduled physical channels. Below, example II of TAB. 1 will be discussed, i.e., variation of the frequency offset across the physical channels. See FIG. 7; here, the frequency offset 719 is illustrated for multiple PDSCHs 611-614.

It is possible that each physical channel has a frequency offset or a sub-set of the jointly scheduled physical channels (e.g., at least two physical channels) may have a frequency offset.

The frequency offset is fixed or configurable frequency offset. The configurable frequency offset may require explicit information. This can be provided as part of the scheduling message. For instance, a predetermined rule can be relied upon.

The values of the frequency offset can be UE-specific.

The frequency offset should be within the current UE's active bandwidth part; i.e., respective upper and lower bounds may be defined.

The frequency offset may depend on the location of the first physical channel. It would be possible that, depending on the frequency location of the first physical channel, an incremental change of the frequency offset is then applied, wherein the direction of the frequency offset increment depends on the frequency location of the first physical channel: negative-if the first physical channel is located in the upper portion of the BWP (e.g. on the upper half of the BWP); or positive: if the first physical channel is located in the lower portion of the BWP (e.g. on the lower half of the BWP). As will be appreciated, in such a scenario the different values of the frequency offset are determined for different physical channels based on a reference frequency offset that is indicated by the scheduling message and a predetermined rule—the predetermined rule specifies a UE-centric decision criterion (position of the first physical channel in the BWP) and an offset value for incrementing the frequency offset.

Above, example II of TAB. 1 has been discussed, i.e., the variation of the value of the frequency offset across the physical channels. Below, example III of TAB. 1 will be discussed, i.e., variation of the timing offset across the physical channels. The timing offset 711 of physical channel 622 is illustrated in FIG. 8. Each physical channel may have a time gap or a sub-set of physical channels (e.g., at least two physical channel) may have a time gap. FIG. 9 illustrates three scenarios in which the time gap—defining the timing offset 711—is varied for the different physical channels 631-634 (first scenario), 641-644 (second scenario), and 651-654 (third scenario).

The variation of the value of the timing offset, e.g., of the time gap, is fixed or configurable. A configurable variation may require explicit information, e.g., at least partly included in the scheduling message.

The variation may be UE-specific.

Also in the scenario, a predetermined rule may be employed to derive the value of the timing offset; e.g., the time gap size is a multiplication of number of slot or sub-slot.

Above, example III of TAB. 1 has been discussed, i.e., the variation of the value of the timing offset across the physical channels. Below, example IV of TAB. 1 will be discussed, i.e., variation of the resource size in time and/or frequency across the physical channels.

Here, the resource size for each physical channel size can be different. Hence, the time domain and/or frequency domain resource assignment (TDRA and/or FDRA) parameter is configurable. To simplify the operation in term of providing the parameters to the UE, it can be based on a look-up table. The lookup table is an implementation of a predetermined rule, as explained above. The lookup table, as explained above, can be fixed in the specification and/or configured by the BS, e.g., using a RRC control message. For instance, the lookup table may include multiple sets of candidate values of the resource size. Then, the scheduling message can include a pointer to a specific one of those sets. It would also be possible to use an incremental change of the resource size value. i.e., a resource that size may be predetermined or configured. Then, the resource size value of a physical channel can be determined in relation to the resource size value of a preceding physical channel of the jointly scheduled physical channels.

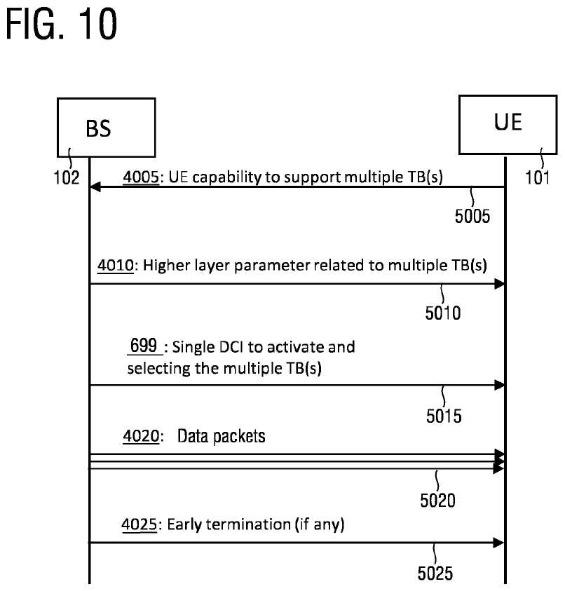

FIG. 10 is a signaling diagram of communication between the UE 101 and the BS 102 on the wireless communication link 105.

Initially, at 5005, the UE 101 provides, to the BS 102, a capability of the UE 101 (a capability message 4005 is indicative of the capability). This capability is associated with the joint scheduling of multiple physical channels carrying different TBs using a single scheduling message. For instance, a respective capability configuration message may be provided, e.g., an RRC control message on Layer 3.

The BS 102 can then determine the number of physical channels that are jointly scheduled using a single scheduling message in accordance with the capability indicated by the UE 101.

For instance, some UEs may not support joint scheduling of multiple physical channels. Other UEs may only support joint scheduling of multiple physical channels up to a certain upper threshold number of physical channels. This may be indicated using the capability message 4005.

Another aspect that can be signaled to the BS 102 as a UE capability—alternatively or additionally to the threshold number of jointly scheduled physical channels—is the type of transmission parameter for which the values may be varied across the subsequent physical channels (cf. TAB. 1). In other words, it would be possible that the capability comprises whether the UE supports different values of the modulation and coding scheme across the physical channels that are jointly scheduled, and/or supports different frequency offsets and/or supports different timing offsets, and/or whether it supports different resource sizes. Respective upper and lower bounds of the values subject to such variation could also be signaled.

Next, at 5010, the BS 102 transmits a configuration message 4010 to the UE 101. The configuration message 4010 is indicative of, e.g., a rule for determining the values of the at least one transmission parameter across the jointly scheduled physical channels. One or more sets of (candidate) values of at least one transmission parameter may be signaled. Offset values for incrementally changing the value of the at least one transmission parameter from physical channel to physical channel may be signaled.

Then, at 5015, a DCI implementing a scheduling message 699 (e.g., DL grant or UL assignment) is transmitted by the BS 102 to the UE 101. The scheduling message schedules multiple physical channels. For example, a predetermined number of physical channels may be scheduled, i.e., a certain finite number of multiple physical channels (in contrast to SPS where the number of physical channels is not predetermined).

The multiple physical channels can be on the same carrier. The multiple physical channels can be on the same bandwidth part. The multiple physical channels may be transmitted using a single antenna port.

The multiple physical channels may be schedule as a sequence, i.e., offset in time domain one after another.

Shared physical channels can be scheduled, e.g., PDSCH or PUSCH. The DCI implementing the scheduling message 699 can include an information element that is indicative of an offset value from the first physical channel for subsequent values of the at least one transmission parameter. For example: The MCS step size can be indicated. It would be possible to indicate a frequency offset value increment. Here, if the frequency offset for the first physical channel is 24 resource blocks, then—using a frequency offset increment of 4—the second physical channel has a size of 28 resource blocks. A timing offset increment could be signaled, e.g., increasing a time gap by 1 slot from physical channel to physical channel.

The DCI implementing the scheduling message 699 may include an indicator indicative of which specific set of MCS offset values (selected from multiple candidate sets). Such pointer can be added as a new DCI parameter. For example, there can be three parameters included in the DCI providing indicators indicative of a variation of values for three different transmission parameters. It would also be possible that a DCI parameter provides an indicator indicative of the variation of multiple different transmission parameters.

For instance, a look-up table may be provided as illustrated in TAB. 2 below.

| Multiple | | | | | |
|---|---|---|---|---|---|
| physical | | | | | |
| channel | MCS | Freq | Time | Freq | Time |
| param index | offset | resource | resource | offset | offset |
| 0 | 0 | 0 | 0 | 0 | 0 |
| 1 | −1 | 0 | 0 | 2 | 0 |
| 2 | −1 | +1 | 0 | 2 | 1 |
| 3 | −2 | 0 | 1 | 0 | 3 |

TAB. 2: Look-up table for configuring a variation of values for multiple transmission parameters (cf. TAB. 1). The scheduling message 699 (implemented by the DCI in the illustrated example) can include an index according to the first column of TAB. 2. Then, different offset values for multiple transmission parameters can be jointly selected. The index of the table (as a new DCI parameter) represents several parameters (MCS, frequency offset, time offset, grouping of PDSCH, time/frequency resources, etc). The look-up table can be fixed in the specifications or conveyed to the UE via higher layer, e.g., at 5010 in FIG. 10. In this example of TAB. 2, multi-physical channel-index=0 means the physical channels use the same values for the transmission parameters across the physical channels (the same MCS, the same FDRA/TDRA, and no frequency and time offset=. For multi-physical channel-index=1, the subsequent physical channel will have a value of the MCS that is one level lower than the MCS value of the preceding physical channel, and with frequency offset of 2 units (e.g., two resource blocks). The FDRA/TDRA remains the same, and so on. The Time Resource can be the duration of the PDSCH/PUSCH, e.g., add or deduct the number of OFDM symbols. The Time Offset is the changes to the starting symbol relative to the slot boundary of the PDSCH/PUSCH.

Then, at 5020, multiple data packets that are mapped to different TBs; the TBs are then carried by the multiple physical channels that have been scheduled at 5015 are communicated from the BS 102 to the UE 101. Each physical channel can carry a single TB.

Different data packets can be mapped to different TBs that are communicated at box 5020. For instance, a video frame of an extended reality application can be split into multiple data packets and those data packets can be mapped to different TBs. This is helpful, because by adjusting the values of one or more transmission parameters across the TBs that are jointly scheduled, and uncertainty in the link conditions for later TBs can be compensated for.

It is optional, as illustrated in FIG. 10, to transmit 5025, from the BS 102 to the UE 101 an early termination indicator 4025. The early termination indicator is communicated from the BS and the UE prior to communicating all of the jointly scheduled physical channels. Subsequent communication of any remaining physical channels that have been initially scheduled using the scheduling message 699 transmitted at 5015 is aborted.

Early termination can be beneficial in case all physical channels are not required to be transmitted. For example, a UE firstly is configured to receive eight physical channels. However, the transmission is completed in seven physical channels. The BS 102 can provide the early termination indicator 4025. This frees up resources on the physical channel; and reduced UE power consumption.

As a general rule, there are various options available for providing the early termination indicator 4025. For instance, the early termination indicator 4025 could be transmitted explicitly using a control channel, e.g., PDCCH for downlink or PUCCH for uplink. It would also be possible that the early termination indicator is piggybacked into one of the physical channels that have been initially scheduled using the scheduling message 699. The early termination indicator could be piggybacked to the last transmitted physical channel.

It would also be possible—alternatively to transmitting the early termination indicator—to transmit, from the BS 102 to the UE 101, and prior to communicating all of the physical channels, a further scheduling message (not illustrated in FIG. 10). This further scheduling message may be configured similar to the initial scheduling message 699 that has been transmitted at 5015, however, indicate different resources for subsequent physical channels. This corresponds to a control channel via PDSCH scenario.

In some scenarios, it would be possible that the further scheduling message schedules a multiple further physical channels, e.g., further PDSCHs or PUSCHs. This can be done prior to completing the communication of the previously scheduled physical channels. In this scenario, different further physical channels can have different values of the at least one transmission parameter. At least one further physical channel can be allocated to the same resources on the wireless communication link then a respective one of the physical channels that has been initially scheduled. In other words, it would be possible that one or more of the initially scheduled physical channels are replaced/overwritten by another scheduling. This allows to accommodate for sudden changes in the condition of the wireless communication link. Also, changes in the required data rate can be accommodated for. The BS can implicitly indicate such replacement of one or more physical channels by scheduling one or more physical channels in the same slots as the physical channels it wishes to replace. For example, a grant may schedule four physical channels, where the MCS, frequency resources & time resources are known after the UE decodes the grant. After the first and second physical channels of those four physical channels are transmitted, the BS may replace the third and fourth physical channel with a different MCS, frequency resource & time resources by transmitting another multi-physical channel scheduling message with two physical channels that replace the third and fourth physical channel from the previous grant. These two further physical channels are scheduled in the same slots as those for the third and fourth physical channel that they replace.

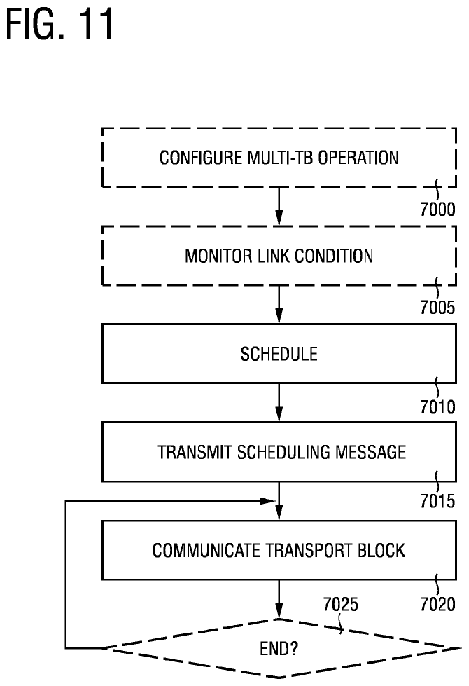

FIG. 11 is a flowchart of a method according to various examples. The method of FIG. 11 can be executed by a BS. For instance, the method of FIG. 11 may be executed by a 3GPP NR gNB. For example, the method of FIG. 11 may be executed by the BS 102 (cf. FIG. 1). The method of FIG. 11 may be executed by the processor 1021 upon loading program code from the memory 1022 and upon executing the program code.

The method of FIG. 11 pertains to techniques of communicating data packets between the BS and a UE, e.g., the UE 101. The method of FIG. 11 pertains to scheduling, using a single scheduling message, multiple physical channels having varying values of at least one transmission parameter.

Optional boxes are illustrated using dashed lines in FIG. 11.

Initially, at box 7000, it is possible to configure multi-physical channel operation. This can include obtaining a capability indicative of whether the UE can support multi-physical channel scheduling. The capability may alternatively or additionally be indicative of certain transmission parameters that may be subject to variation of their values across the multiple physical channels that are jointly scheduled. Respective techniques have been explained in connection with FIG. 10: 5005.

Box 7000 may, alternatively or additionally, include communicating a configuration message between the UE and the BS that is indicative of a predetermined rule for determining values of at least one transmission parameter across the physical channels. Respective techniques have been discussed in connection with FIG. 10: 5010.

Next, at box 7005, it is optionally possible to monitor a link condition of a wireless communication link between the BS and the UE. For instance, techniques of channel sounding may be employed using reference signals. A received signal strength of the reference signals may be determined. An expected bit error rate may be determined.

At box 7010, scheduling is executed. PUSCHs or PDSCHs are scheduled. TBs are carried by the PUSCHs or PDSCHs. TBs are used as containers to convey data packets on the resources allocated to the PUSCHs or PDSCHs. A TB can have a certain size and consequently the physical channel can have certain sizes, e.g., include a certain number of time-frequency resources, typically in units of resource blocks. A physical channel carrying a TB is also characterized by certain values of multiple transmission parameters, e.g., MCS, time offset, frequency offset, and so forth.

The scheduling at box 7010 also includes determining values of transmission parameters to be used for the respective scheduled physical channels.

The scheduling at box 7010 also includes determining how to inform the UEs about the allocated resources using respective scheduling messages.

According to examples, for a given UE, a single scheduling message may be used (box 7015) that schedules multiple physical channels (specifically physical shared channels), e.g., a certain predetermined number of physical channels. A so-called multi-physical channel scheduling message may be used. A multi-physical channel scheduling message has been discussed in connection with FIG. 10: 5015.

The jointly scheduled physical channels can be located in different timeslots of the wireless communication link. The different physical channels can have different values for a least one transmission parameter (cf. TAB. 1).

According to examples, at box 7015 multiple physical channels—e.g., a predetermined finite number—are scheduled, the physical channels having varying values of at least one transmission parameter (cf. TAB. 1). The scheduling can depend on the monitoring of the link condition at box 7005. For instance, different values of the at least one transmission parameter can be used depending on the link condition as determined in box 7005. Thereby, varying link conditions can be dynamically addressed using the scheduling at box 7010. For instance, it would be possible to predict a reliability of communicating on the wireless communication link for multiple time intervals (e.g., time slots or subframes) that are associated with each one of the physical channels. Such prediction can be based on the currently observed link condition, monitored in box 7005.

To give an example, it would be possible that there is a tendency that a lower link quality that is currently observed also results in a lower predicted link quality in the future. However, certain temporary dips in the link quality can be known to be of temporary nature. For instance, a temporary fading artifact can be known to resolve after a certain time span. Then, it is expected that the link quality will recover. On the other hand, it is possible to assume that the uncertainty in the prediction of the link quality increases for longer prediction periods.

It would be possible that multiple physical channels are scheduled, wherein different ones of these multiple physical channels are located in different timeslots. Then, would be possible that the link quality is predicted for the different timeslots. It would then be possible to determine the values of the at least one transmission parameters that are varied across the multiple physical channels based on the predicted reliability. For instance, the predicted reliability is suggesting a decrease link quality, e.g., a higher bit error rate, then, this may be mitigated by providing for a more robust modulation and coding. The value of the MCS can be determined accordingly. Likewise, if the predicted reliability suggests certain frequencies to be more affected by a poor link quality than other frequencies, then the frequency offset may be chosen accordingly. Similar considerations apply to the timing offset.

Once the scheduling message has been transmitted by the BS to the UE at box 7015, then the physical channels that have been jointly scheduled using that scheduling message are subsequently communicated in subsequent iterations of box 7020. After each physical channel, it can be checked, at box 7025, whether a further physical channel is to be communicated. It can be checked whether all physical channels that were initially scheduled have been communicated. It can be checked whether the UE has meanwhile disconnected or been released. Also, early termination may be checked: an early termination indicator may be communicated to further physical channels are not required (cf. FIG. 10: 5025). It would also be possible to override the initial scheduling of box 7010 with a new scheduling, by transmitting a new scheduling message. For instance, the new scheduling message may re-allocate resource blocks previously allocated to a given physical channel to another physical channel.

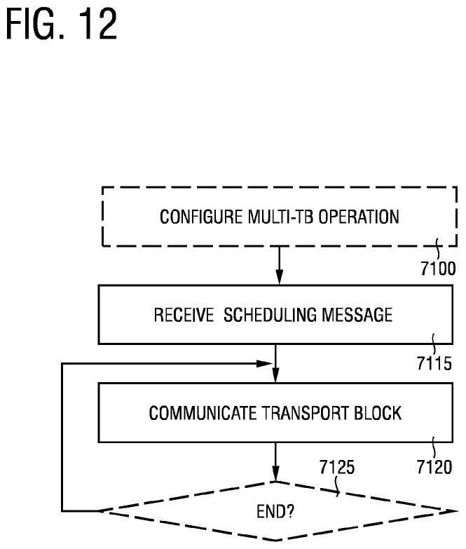

FIG. 12 is a flowchart of a method according to various examples. The method of FIG. 12 can be executed by a UE. For instance, the method of FIG. 12 may be executed by a 3GPP NR UE. For example, the method of FIG. 12 may be executed by the UE 101 (cf. FIG. 1). For instance, the method of FIG. 12 may be executed by the processor 1011 upon loading program code from the memory 1012 and upon executing the program code.

The method of FIG. 12 pertains to techniques of communicating data packets between a BS and the UE, e.g., the BS 102 and the UE 101. The method of FIG. 12 pertains to scheduling, using a single scheduling message, multiple physical channels having varying values of at least one transmission parameter.

Optional boxes are illustrated using dashed lines in FIG. 12.

The method of FIG. 12 is interrelated to the method of FIG. 11.

At box 7100, it is possible to configure multi-physical channel operation. Box 7100 is inter-related to box 7000. Respective details as explained in connection with box 7000 also apply to box 7100.

At box 7115, the UE receives a scheduling message. Details with respect to the scheduling message have been explained above in connection with box 7015. The scheduling message schedules multiple physical channels, e.g., a predetermined number of physical channels, wherein values of at least one transmission parameter vary across the jointly scheduled physical channels.

At box 7120, physical channels as scheduled by the scheduling message at box 7115 are then communicated either an uplink or downlink. Details with respect to such communication have been explained above in connection with box 7020.

At box 7125, the UE can then check optionally whether an early termination or replacement of the initially scheduled remaining physical channels occurs, as previously explained in connection with box 7025. The UE may transmit an early termination indication; or may receive another multi-physical channel scheduling message overwriting the previous multi-physical channel scheduling message.

Summarizing, techniques have been disclosed on how to use a single DCI implementing a scheduling message that jointly schedules a set of multiple physical channels having a certain size, i.e., jointly scheduling multiple physical channels

The scheduling can consider a reliability of communicating on a respective wireless communication link. For instance, the reliability may be considered by applying different values of a modulation and coding scheme to the different physical channels. For instance, a more robust modulation and coding scheme can be used in later physical channels. For instance, it would be possible to map the multiple physical channels and the applied values of the modulation and coding scheme.

Alternatively or additionally, the reliability of communicating on the wireless link can be considered by varying the size of the physical channel in time/frequency domain. Frequency hopping operation could be used. Subsequent transmissions can be allocated in better channel conditions. Also, a flexibility in allocating the time domain resources for the multiple physical channels is provided. A timing offset may be varied from physical channel to physical channel. Time gaps can be accommodated between subsequent physical channels that are jointly schedule. FDRA and TDRA can be varied.

Techniques have been disclosed to accommodate certain information helpful for varying the values of the at least one transmission parameter across multiple physical channels in the scheduling message, e.g., techniques of modifying the DCI contents have been disclosed. It is possible to explicitly indicate the values of the at least one transmission parameter to be used across the multiple physical channels in the scheduling message. Alternatively, to reduce the information content to be carried by the scheduling message, it would be possible to rely on a predetermined rule. It would be possible that the predetermined rule is fixedly specified in the specification or is indicated by a higher-layer configuration message, e.g., a RRC control message.

Techniques for early termination of the communication of the physical channels, prior to completing the communication of the jointly schedule physical channels, have been disclosed.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustrated, the disclosed scenarios can be combined with prior art implementations for HARQ operation, e.g., as explained in connection with FIG. 2, FIG. 3, FIG. 4, and FIG. 5.

For further illustration, various examples have been disclosed for downlink communication; nonetheless, similar techniques may be readily applied for uplink communication, i.e., for scheduling physical channels on an uplink shared channel.

For still further illustration, above, various scenarios have been disclosed for a wireless communication link that is between a BS of a cellular NW and a UE. According to various examples, similar techniques may also be applied to other types of wireless communication systems. For instance, the wireless communication link may extend between an access node of a local area network and a UE and operate according to the IEEE Wi-Fi protocol.

1. A method of operating a base station, the method comprising:
transmitting a scheduling message to a wireless communication device via a wireless communication link, the scheduling message scheduling a plurality of physical channels to carry different transport blocks, different physical channels being associated with different values of at least one transmission parameter, and
communicating, between the base station and the wireless communication device and on the wireless communication link, at least one of the plurality of physical channels.

2. The method of claim 1,
wherein the scheduling message comprises an indicator that at least partly determines the different values of the at least one transmission parameter.

3. The method of claim 2,
wherein the indicator included in the scheduling message provides a selection of the different values of the at least one transmission parameter from multiple candidate values that are predetermined at the base station and the wireless communication device.

4. The method of claim 2,
wherein the determining of the different values of the at least one transmission parameter is in accordance with a predetermined rule pre-defined at the base station and the wireless communication device.

5. The method of claim 4, further comprising:
communicating, between the wireless communication device and the base station, at least one configuration message indicative of the predetermined rule.

6. The method of claim 5,
wherein the at least one configuration message is native to Layer 3 of a communication protocol stack employed for communication between the wireless communication device and the base station.

7. The method of claim 1,
wherein the scheduling message comprises an indicator indicative of an offset between the different values of the at least one transmission parameter.

8. The method of claim 1,
wherein the at least one transmission parameter comprises a modulation and coding scheme of the plurality of physical channels.

9. The method of claim 8,
wherein the scheduling message is indicative of a reference value of the modulation and coding scheme,
wherein the different values of the modulation and coding scheme are determined for the different physical channels of the plurality of physical channels based on the reference value of the modulation and coding scheme and a predetermined rule.

10. The method of claim 8,
wherein the scheduling message comprises a pointer to a specific set of multiple predetermined sets of values of the modulation and coding scheme.

11. The method of claim 8,
wherein the scheduling message is indicative of an incremental increase or decrease of a level of the modulation and coding scheme from physical channel to physical channel of the plurality of physical channels.

12. The method of claim 8,
wherein a level of the modulation or coding scheme is increased across the plurality of physical channels in case a temporary drop of a channel condition of the wireless communication link is observed,
wherein a level of the modulation and coding scheme is decreased across the plurality of physical channels in case the temporary drop of the channel condition of the wireless communication link is not observed.

13. The method of claim 8,
wherein the scheduling message comprises an indicator indicative of at least one modulation and coding scheme offset, thereby incrementally defining the different values of the modulation and coding scheme.

14. The method of claim 8,
wherein the values of the modulation and coding scheme are selected in accordance with at least one of a predetermined upper bound or a predetermined lower bound.

15. The method of claim 1,
wherein the at least one transmission parameter comprises a frequency offset.

16. The method of claim 15,
wherein different values of the frequency offset are determined for the physical channels of the plurality of physical channels based on a reference frequency offset indicated by the scheduling message and a predetermined rule.

17. The method of claim 1,
wherein the at least one transmission parameter comprises a timing offset.

18. The method of claim 17,
wherein different values of the timing offset are determined for the physical channels of the plurality of physical channels based on a predetermined rule.

19. The method of claim 1,
wherein the at least one transmission parameter comprises a resource size of the physical channels of the plurality of physical channels.

20-28. (canceled)

29. A method of operating a wireless communication device, comprising:
receiving a scheduling message from a base station via a wireless communication link, the scheduling message scheduling a plurality of physical channels carrying different transport blocks, different physical channels of the plurality of physical channels being associated with different values of at least one transmission parameter, and
communicating, between the base station and the wireless communication device and on the wireless communication link, at least one of the plurality of physical channels.

30-56. (canceled)
